(19) United States
(12) Patent Application Publication
(10) Pub. No.: US 2026/0260978 A1
(43) Pub. Date: Sep. 3, 2026

(54) SECONDARY BATTERY

(71) Applicant: KABUSHIKI KAISHA TOSHIBA, Kawasaki-shi (JP)

(72) Inventors: Kengo SUGIMOTO, Yokohama Kanagawa (JP); Kenji WATANABE, Yokohama Kanagawa (JP); Naoki IWAMURA, Kamakura Kanagawa (JP); Zhi LI, Kawasaki Kanagawa (JP)

(73) Assignee: KABUSHIKI KAISHA TOSHIBA, Kawasaki-shi (JP)

(21) Appl. No.: 19/545,078

(22) Filed: Feb. 20, 2026

(30) Foreign Application Priority Data
Mar. 3, 2025 (JP) 2025-033263

(51) Int. Cl. H01M 50/15; H01M 50/103; H01M 50/55; H01M 50/557; H01M 50/627

(52) U.S. Cl. CPC H01M 50/15; H01M 50/103; H01M 50/55; H01M 50/557; H01M 50/627

(57) ABSTRACT

According to one embodiment, there is provided a secondary battery includes an outer case including a bottom wall, a side wall, and an aperture portion, and an electrode assembly in the outer case and including a positive electrode, a negative electrode, and a lid member disposed at the aperture portion and having a first through-hole, and an electrode assembly retainer provided between the electrode assembly and the lid member and having a second through-hole, and an external terminal having a shaft portion in the first through-hole and the second through-hole. The electrode assembly retainer includes an inclined portion that is inclined with respect to the lid member at an angle of 5° or more and 20° or less in the direction in which the electrode assembly is inserted.

This application is based upon and claims the benefit of priority from Japanese Patent Application No. 2025-033263, filed Mar. 3, 2025, the entire contents of which are incorporated herein by reference.

### FIELD

Embodiments described herein relate generally to a secondary battery.

### BACKGROUND

In recent years, secondary batteries such as lead-acid batteries and nickel-metal hydride batteries have been used as power sources represented by electric vehicles, hybrid vehicles, electric motorcycles, forklifts, and the like. Recently, development toward adoption of a lithium-ion secondary battery having a high energy density has been actively conducted, and development has been conducted in consideration of long life, safety, and the like.

A general lithium-ion secondary battery (hereinafter simply referred to as a “secondary battery”) may be manufactured by housing an electrode assembly including a positive electrode and a negative electrode in an outer case having an opening, and arranging a lid member at the opening of the outer case. Inside the outer case, an electrode assembly retainer may be provided between the electrode assembly and the lid member.

In such a secondary battery, when an external load is applied, the electrode assembly inside the secondary battery may be displaced due to this load. External loads include, for example, vibration during operation of a vehicle equipped with the secondary battery or impacts in the event of a collision. When such a load is applied to the secondary battery and the internal electrode assembly is not sufficiently constrained by the electrode assembly retainer or the like, the internal electrode assembly may become displaced. Such displacement may cause breakage in the tabs or lead portions of the electrode assembly. When a portion of the electrode assembly breaks, the battery may experience increased resistance, decreased capacity, or even short circuit.

### BRIEF DESCRIPTION OF THE DRAWINGS

FIG. 1 is a perspective view schematically showing a secondary battery of a first embodiment.

FIG. 2 is an exploded perspective view schematically showing the secondary battery of the first embodiment in a state disassembled by component.

FIG. 3 is a cross-sectional view of the vicinity of the electrode assembly retainer along line I-I in FIG. 1 in the first embodiment.

FIG. 4 is a cross-sectional view of the vicinity of the electrode assembly retainer along line I-I in FIG. 1 in the second embodiment.

### DETAILED DESCRIPTION

In general, according to one embodiment, there is provided a secondary battery includes an outer case including a bottom wall, a side wall, and an aperture portion, and an electrode assembly in the outer case and including a positive electrode, a negative electrode, and a lid member disposed at the aperture portion and having a first through-hole, and an electrode assembly retainer provided between the electrode assembly and the lid member and having a second through hole, and an external terminal having a shaft portion in the first through hole and the second through hole. The electrode assembly retainer includes an inclined portion that is inclined with respect to the lid member at an angle of 5° or more and 20° or less in the direction in which the electrode assembly is inserted.

Hereinafter, a secondary battery according to an embodiment will be described with reference to the drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc. of the respective parts are schematically illustrated in the drawings, compared to the actual modes. However, the schematic illustration is merely an example and adds no restrictions to the interpretation of the invention. In addition, in the specification and drawings, the same elements as those described in connection with preceding drawings are denoted by like reference numbers, and detailed description thereof is omitted or simplified unless necessary.

### First Embodiment

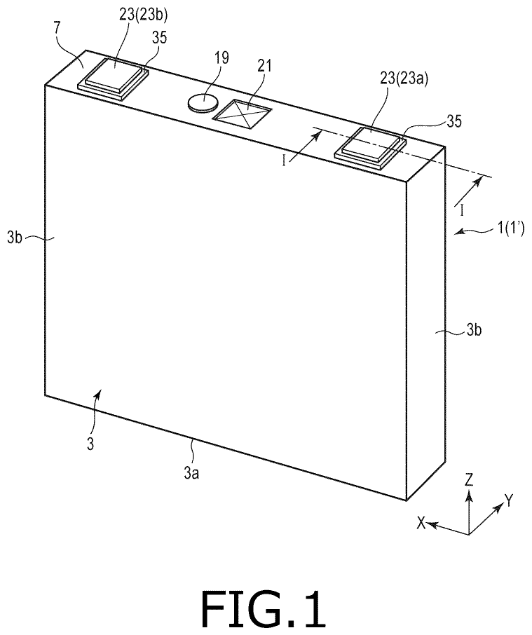

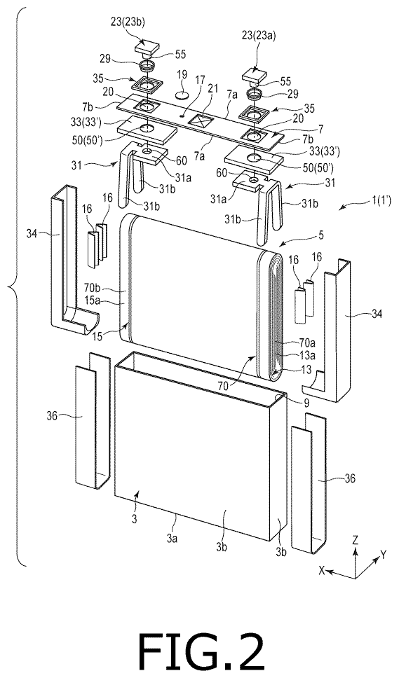

A secondary battery 1 of a first embodiment will be described with reference to FIGS. 1 and 2. FIG. 1 is a perspective view schematically showing a secondary battery according to a first embodiment. FIG. 2 is an exploded perspective view schematically showing the secondary battery of the first embodiment in a state disassembled by component.

In the figures, the width direction of the outer case is defined as the X-direction, the height direction (the direction in which the electrode assembly is inserted) is defined as the Z-direction, and the thickness direction orthogonal to these is defined as the Y-direction

As shown in FIGS. 1 and 2, the secondary battery 1 includes an outer case 3 and an electrode assembly 5. For example, the outer case 3 has a tubular shape with a bottom wall 3a and side walls 3b. A tubular shape usually has circular, square or rectangular sections, although other shaped sections are possible. An aperture portion 9 is provided at the upper surface of the outer case 3. For example, a lid member 7 having a first through-hole 20 is provided in the aperture portion 9. The outer case 3 and the lid member 7 are formed of a metal such as aluminum, aluminum alloy, iron, copper, or stainless steel. The secondary battery 1 only needs to include the outer case 3 and the electrode assembly 5. The bottom wall and the aperture portion 9 are not limited to a rectangular shape, and the outer case 3 is not limited to a tubular shape.

In the secondary battery 1 of the present embodiment, the lid member 7 is provided with a gas vent valve 21 and a liquid injection port 17, although these components are optional. The liquid injection port 17 is sealed by a sealing plate 19. The aperture portion 9 and the lid member 7 are not limited to a rectangular shape but may preferably be in a rectangular shape with a pair of long sides 7a and a pair of short sides 7b.

As shown in FIG. 2, the electrode assembly 5 is manufactured, for example, by winding a positive electrode 13, a negative electrode 15, and a separator (not shown) interposed between the positive electrode 13 and the negative electrode 15 around an axis and then pressing the whole to form a flat shape.

The positive electrode 13 includes a positive current collector 13a and a positive active material supporter portion (not shown) supported on the positive current collector 13a. The positive current collector 13a includes a positive current collector tab 70a as a part where the positive active material supporter portion is not coated.

In contrast, the negative electrode 15 includes a negative current collector 15a and a negative active material supporter portion (not shown) supported on the negative current collector 15a. The negative current collector 15a includes a negative current collector tab 70b as a part where the negative active material supporter portion is not coated.

The positive current collector tab 70a and the negative current collector tab 70b are sometimes collectively referred to as current collector tabs 70. The electrode assembly 5 may have a stack structure manufactured by alternately stacking the plurality of positive electrodes 13 and the plurality of negative electrodes 15 with separators interposed therebetween. When the electrode assembly 5 having the stack structure is employed, the connection structure with the outer case 3 is modified as appropriate. The electrode assembly 5 is not limited to the wound structure and the stack structure.

In the present embodiment, the electrode assembly 5 is a wound body, and multiple layers of the positive current collector tabs 70a and the negative current collector tabs 70b are provided at least at one end of the electrode assembly 5. The positive and negative current collector tabs 70a and 70b are provided at both ends of the electrode assembly 5 and extend in a direction orthogonal to the insertion direction (the Z-direction) of the electrode assembly 5 into the outer case 3. The positive current collector tab 70a extends in the opposite direction from the negative current collector tab 70b. The extension directions of the positive current collector tab 70a and the negative current collector tab 70b are not limited to these directions. For example, both current collector tabs 70a and 70b may extend in the same direction and be provided at one end of the electrode assembly 5.

When the electrode assembly 5 having the wound structure is used and the wound current collector tabs 70 are provided at both ends in the direction of the winding axis as in the present embodiment, the ends of the current collector tabs 70 are preferably clamped by two or more metal members 16. Here, clamping signifies that the metal member 16 bundles and integrates the plurality of current collector tabs 70. At least part of the metal member 16 needs to contact one face and the other face of the current collector tab 70.

Stable clamping of the current collector tabs 70 by the metal members 16 is thereby achieved even when, for example, the weight of the electrode assembly 5 is increased as a means of increasing the capacity of the secondary battery 1. Here, increasing the weight of the electrode assembly 5 includes enlarging the dimensions of the electrode assembly or increasing the number of windings of the electrodes to increase the mass of the electrode active material. The number of the metal members 16 provided for each of the current collector tabs 70 at the respective ends of the electrode assembly 5 is not limited to these examples. At least one of the current collector tabs 70 at the respective ends of the electrode assembly 5 is preferably clamped by one or more metal members 16.

In the secondary battery 1 of the present embodiment, an electrode assembly retainer 33 having a second through-hole 50 is provided between the electrode assembly 5 and the lid member 7. The electrode assembly retainer 33 may be provided as a pair, separated into a positive electrode side and a negative electrode side, or it may be provided as a single integrated component. The electrode assembly retainer 33 is an insulating member and is provided near the electrode assembly 5. The positional relationship of the first through-hole 20 in the lid member 7 and the second through-hole 50 in the electrode assembly retainer 33 is aligned in the insertion direction (the Z-direction) of the electrode assembly 5 into the outer case 3.

Shaft portions 55 of external terminals 23a and 23b are provided in the first through-hole 20 of the lid member 7 and the second through-hole 50 of the electrode assembly retainer 33. The external terminals 23a and 23b are formed of a conductive material such as metal, and their shaft portions 55 are provided in close contact with the lid member 7 via an insulating gasket 29. The shaft portion 55 may be connected to a conductive member 31 through a third through-hole 60 formed in the conductive member 31. It is preferable that the positional relationship of the first through-hole 20 in the lid member 7, the second through-hole 50 in the electrode assembly retainer 33, and the third through-hole 60 in the conductive member 31 be aligned in the Z-direction.

The conductive member 31 includes a first substrate portion 31a, which is provided between the electrode assembly 5 and the electrode assembly retainer 33, and a second substrate portion 31b, which is provided between the electrode assembly 5 and the side wall 3b of the outer case 3 and is connected to the first substrate portion 31a. In this embodiment, the conductive member 31 has two second substrate portions 31b for one first substrate portion 31a. However, the number of second substrate portions is not limited to two.

It is preferable that the conductive member 31 be joined to the metal members 16 that clamp the current collector tabs 70, such that the electrode assembly 5 is electrically connected to the external terminals 23 via the metal members 16 and the conductive member 31. When the conductive member 31 is joined to the metal members 16, the risk of breaking the current collector tabs 70 during joining is reduced compared to directly joining the conductive member 31 to the current collector tabs 70. Here, the external terminal connected to the positive current collector tab 70a is referred to as the positive external terminal 23a, and the external terminal connected to the negative current collector tab 70b is referred to as the negative external terminal 23b.

In this embodiment, the current collector tabs 70 are electrically insulated from the outer case 3 by an insulating cover 34 provided between the tabs and the outer case. The insulating cover 34 may be secured to the electrode assembly 5 with an insulating tape 36. A terminal insulator 35 may be provided between the external terminals 23a and 23b and the lid member 7 such that the external terminals 23a and 23b are electrically insulated from the lid member 7.

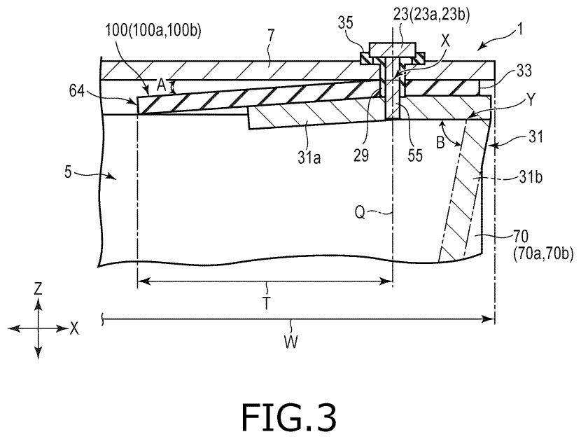

The following will describe the electrode assembly retainer 33 used in the secondary battery 1 of this embodiment with reference to FIG. 3. FIG. 3 is a cross-sectional view of the vicinity of the electrode assembly retainer 33 along line I-I in FIG. 1. As shown in FIG. 3, the electrode assembly retainer 33 has an inclined portion 100 that is inclined with respect to the lid member 7 in the Z-direction, which is the insertion direction of the electrode assembly 5. Here, the inclined portion 100 is defined as the region extending from a point X where a line Q parallel to the Z-direction and passing through the center of the shaft portion 55 of the external terminal 23 intersects the surface of the electrode assembly retainer 33 (the surface facing the lid member 7) toward a direction inclined relative to the lid member 7.

In one example, the inclined portion 100 is inclined with respect to the lid member 7 at an angle A of 5° or more and 20° or less. Specifically, the angle A is defined as the angle formed between the rear surface of the lid member 7 (the surface facing the electrode assembly retainer 33) and the surface of the electrode assembly retainer 33 (the surface facing the lid member 7) at point X.

Because the electrode assembly retainer 33 includes the inclined portion 100, the rear surface of the electrode assembly retainer 33 is positioned closer to the electrode assembly 5 compared to a case without such an inclined portion, and the inclined portion 100 near the electrode assembly 5. When the angle A of the inclined portion 100 is 5° or more, at least part of the inclined portion 100 readily contacts the electrode assembly 5, allowing the electrode assembly retainer 33 to restrain the electrode assembly 5 at the contact point. When the angle A of the inclined portion 100 is 20° or less, deformation (Z-direction deformation) of the electrode assembly 5 due to contact with the inclined portion 100 can be suppressed while still sufficiently restraining the electrode assembly 5. A preferable angle A is 15°.

By restraining the electrode assembly 5 in the height direction (the Z-direction) of the secondary battery 1 using the inclined portion 100 of the electrode assembly retainer 33, displacement of the electrode assembly 5 can be suppressed even when external loads such as vibration or impact are applied to the secondary battery 1. The electrode assembly retainer 33 of this embodiment is particularly effective in suppressing vibration and impacts in the Z-direction. Thus, according to this embodiment, breakage of parts of the electrode assembly 5 due to displacement, and an increase in battery resistance, a decrease in capacity, or short circuit caused by such breakage can all be suppressed.

As described above, in the secondary battery 1 of this embodiment, an insulating cover 34 may be provided in the width direction (the X-direction) of the battery. In this case, the electrode assembly 5 is restrained in the X-direction by the insulating cover 34. Therefore, when the electrode assembly 5 is also restrained in the Z-direction by the inclined portion 100 of the electrode assembly retainer 33, the electrode assembly 5 is sufficiently restrained in both the X-direction and the Z-direction. As a result, a secondary battery 1 with enhanced vibration resistance and impact resistance can be obtained.

The method for providing the inclined portion 100 of the electrode assembly retainer 33 will now be described. The inclined portion 100 may be provided by preparing an electrode assembly retainer 33 having the angle A in advance, or by preparing an electrode assembly retainer 33 without the inclined portion and forming the inclined portion 100 during assembly of the secondary battery 1. In the latter case, the electrode assembly retainer 33 having the second through-hole 50 is first placed beneath the lid member 7 having the first through-hole 20. Then, the shaft portion 55 of the external terminal 23 (23a, 23b) is inserted into the first through-hole 20 and the second through-hole 50. After that, an appropriate load is applied from above the external terminal 23 (23a, 23b) such that the external terminal 23 closely contacts the first through-hole 20 of the lid member 7 and the second through-hole 50 of the electrode assembly retainer 33. This load is applied, the electrode assembly retainer 33 undergoes deformation due to the load, forming the inclined portion 100. Since the angle A depends on parameters such as the thickness and material of each component and the dimensions of the electrode assembly retainer 33, the applied load must be selected such that the angle A becomes 5° or more and 20° or less.

Specifically, an appropriate load is one that forms the inclined portion 100 such that the angle A becomes 5° or more and 20° or less and is higher than the load used in a case where no inclined portion 100 is provided.

The inclined portion 100 of the electrode assembly retainer 33 is formed to extend from the point X at which the shaft portion 55 of the external terminal 23 is provided toward a direction inclined relative to the lid member 7. More preferably, inclined portions are provided on both the positive external terminal 23a side and the negative external terminal 23b side. Here, the inclined portion 100 of the electrode assembly retainer 33 on the positive external terminal 23a side is referred to as the first inclined portion 100a, and the inclined portion 100 on the negative external terminal 23b side is referred to as the second inclined portion 100b.

The first inclined portion 100a and the second inclined portion 100b are provided separately from each other. In the secondary battery 1 of this embodiment, the electrode assembly retainer 33 itself is provided as separate pieces, and thus the first inclined portion 100a and the second inclined portion 100b are also provided separately. As noted above, the inclined portions 100 are formed by applying a load from above the external terminals 23 (23a, 23b). Because the electrode assembly retainer 33 is provided in separate pieces, the load can be readily applied to the retainer 33 on both the positive electrode side and the negative electrode side, making it easy to form the inclined portions 100a and 100b at suitable angle A. When both inclined portions 100a and 100b contact the electrode assembly 5, the electrode assembly 5 can be sufficiently restrained on both the positive-electrode side 13 and the negative-electrode side 15.

As described above, in the secondary battery 1 of this embodiment, the lid member 7 may be provided with a gas vent valve 21 and a liquid injection port 17. In this case, the inclined portion 100 of the electrode assembly retainer 33 is provided so as not to overlap, in the Z-direction (the insertion direction of the electrode assembly 5), with at least one of the gas vent valve 21 and the liquid injection port 17. Here, it suffices that the inclined portion 100 does not overlap the centers of the gas vent valve 21 and the liquid injection port 17. By arranging the inclined portion 100 so as not to overlap the gas vent valve 21 in the Z-direction, even if excessive gas generation occurs within the electrode assembly 5, the inclined portion 100 will not block the gas flow path, and a flow path to the gas vent valve 21 can be ensured. This enables appropriate gas discharge and thereby ensures improved safety of the secondary battery 1. Moreover, by arranging the inclined portion 100 so as not to overlap the liquid injection port 17 in the Z-direction, when electrolyte is injected through the port 17, the inclined portion 100 will not obstruct the injection process, and the electrolyte can reach the electrode assembly 5 directly, improving electrolyte injection performance.

Next, the length of the inclined portion 100 of the electrode assembly retainer 33 will be described with reference to FIG. 3. Although the bottom wall 3a and the aperture portion 9 of the secondary battery 1 are not limited to a rectangular shape, a rectangular shape having long sides and short sides is preferable. The length of the inclined portion 100 is compared with the length (W) of the long side 7a of the lid member 7 in this embodiment. Here, if T denotes the maximum distance of the inclined portion 100 measured parallel to the long side 7a of the lid member 7, then the sum of these distances T is 60% or more and 75% or less of the length W. The sum of distances T contemplates the total of the distances T of the first inclined portion 100a and the second inclined portion 100b, and if there is only one inclined portion 100, a single distance T is sufficient.

When the sum of the distances T of the inclined portions 100 is 60% or more of the length W, the end portion 64 of the inclined portion 100 is separated by a sufficient distance T from the external terminal 23 to which the load is applied. Consequently, deformation in the Z-direction is likely to occur particularly at the end portion 64 of the inclined portion 100 under the load, and the inclined portion 100 readily comes into contact with the electrode assembly 5. Further, when the total of the distances T is 75% or less of the length W, the inclined portion 100 can be provided so as not to overlap the gas vent valve 21 or the liquid injection port 17 in the Z-direction, thereby ensuring the improved safety of the secondary battery 1 while also improving electrolyte injection performance.

As described above, in some cases in the secondary battery 1 of this embodiment, the shaft portion 55 of the external terminal 23 is connected to the conductive member 31 through the third through-hole 60. In the Z-direction (the insertion direction of the electrode assembly 5), it is preferable that the angle B formed by the first substrate portion 31a and the second substrate portion 31b toward the inclined portion 100 is 65° or more and 85° or less. Specifically, the angle B is defined as the angle formed at a point Y where the rear surface of the first substrate portion 31a (surface facing the electrode assembly 5) intersects with the inner surface of the second substrate portion 31b (surface facing the electrode assembly 5) between those two surfaces.

By providing the conductive member 31 in the width direction (the X-direction) of the secondary battery 1 such that the second substrate portion 31b is provided near the current collector tabs 70 of the electrode assembly 5, the electrode assembly 5 can be restrained in the X-direction as well. When the angle B formed by the first substrate portion 31a and the second substrate portion 31b is 85° or less, the second substrate portion 31b easily enters the inside of the current collector tabs 70, enabling the electrode assembly 5 to be restrained by the conductive member 31 in the X-direction. When the angle B is 65° or more, excessive intrusion of the second substrate portion 31b into the current collector tabs 70 can be prevented, thereby preventing deformation of the electrode assembly 5. At the same time, contact between the second substrate portion 31b and the active material within the electrode assembly 5 rather than the current collector tabs 70 can be prevented, thereby suppressing short circuit of the secondary battery 1 due to such contact. A preferable angle B is 65° or more and 75° or less.

A method for setting the angle B of the conductive member 31 will be described. One may use a conductive member 31 that has the angle B of this embodiment in advance or prepare a conductive member 31 without the angle B and form the angle B during assembly of the secondary battery 1. In the latter case, the electrode assembly retainer 33 having the second through-hole 50 is disposed beneath the lid member 7 having the first through-hole 20, and then the conductive member 31 having the third through-hole 60 is provided. The shaft portion 55 of the external terminal 23 is then inserted into the first through-hole 20, the second through-hole 50, and the third through-hole 60. Thereafter, by applying an appropriate load from above the external terminals 23 (23a, 23b), the external terminals 23 are brought into close contact with the first through-hole 20 of the lid member 7, the second through-hole 50 of the electrode assembly retainer 33, and the third through-hole 60 of the conductive member 31. This load is applied, the conductive member 31 undergoes deformation due to the load, and the angle B is formed. Since the thickness and materials of the components of the target secondary battery 1, the dimensions of the electrode assembly retainer 33, and other conditions affect the resultant deformation, the load must be selected such that the angle B becomes 65° or more and 85° or less.

In this embodiment, the electrode assembly 5 is restrained in the height direction (the Z-direction) by the inclined portion 100 of the electrode assembly retainer 33, and in the width direction (the X-direction) by the conductive member 31 and the insulating cover 34. As a result, the electrode assembly 5 is sufficiently restrained in both the X-direction and the Z-direction, and even when external loads such as vibration or impact are applied to the secondary battery 1, displacement of the electrode assembly 5 can be suppressed by the electrode assembly retainer 33, the conductive member 31, and the insulating cover 34. Accordingly, breakage of portions of the electrode assembly 5 due to displacement, an increase in resistance or a decrease in capacity of the secondary battery 1 due to such breakage, and even short circuit can be suppressed.

In the secondary battery 1 of the first embodiment described above, the electrode assembly retainer 33 has the inclined portion 100, and the angle A of the inclined portion 100 is 5° or more and 20° or less. Consequently, the inclined portion 100 of the electrode assembly retainer 33 contacts the electrode assembly 5, and the electrode assembly 5 can be sufficiently restrained at the contact point or contact surface between the retainer 33 and the electrode assembly 5.

Furthermore, in some cases a conductive member 31 is provided in the width direction (the X-direction) of the secondary battery 1, in which case the angle B of the conductive member 31 is 65° or more and 85° or less. In such case, since the second substrate portion 31b of the conductive member 31 is provided inside the current collector tabs 70 in the width direction (the X-direction) of the secondary battery 1, the electrode assembly 5 can be restrained by the conductive member 31 over a wide range in the X-direction. In some cases, the insulating cover 34 is also provided in the width direction (the X-direction) of the secondary battery 1, in which case the electrode assembly 5 is also restrained by the insulating cover 34 in the X-direction.

In this embodiment, the electrode assembly 5 is restrained not only in the height direction (the Z-direction) by the inclined portion 100 of the electrode assembly retainer 33, but also in the width direction (the X-direction) by the conductive member 31 and the insulating cover 34. As a result, the electrode assembly 5 is sufficiently restrained in both the X-direction and the Z-direction, and even when external loads such as vibration or impact are applied to the secondary battery 1, displacement of the electrode assembly 5 can be suppressed by the electrode assembly retainer 33, the conductive member 31, and the insulating cover 34, thereby achieving excellent vibration and impact resistance. Accordingly, breakage of portions of the electrode assembly 5 due to displacement, an increase in resistance or a decrease in capacity of the secondary battery 1 due to such breakage, and even short circuit can be suppressed.

### Second Embodiment

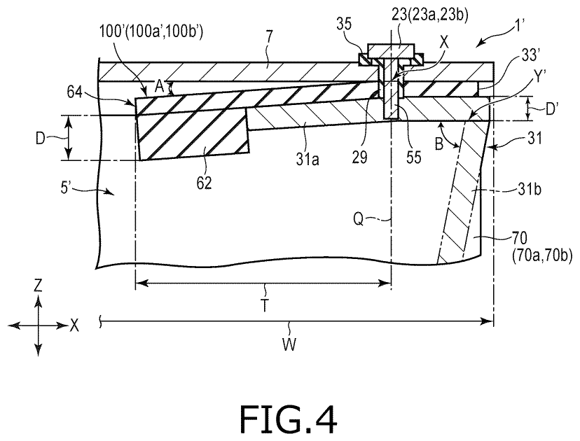

The following will describe a modified example of an electrode assembly retainer 33′ used in the secondary battery 1′ of this embodiment with reference to FIG. 4. FIG. 4 is a cross-sectional view of the vicinity of the electrode assembly retainer 33′ along line I-I in FIG. 1.

The electrode assembly retainer 33′ of this embodiment differs from the electrode assembly retainer 33 of the first embodiment in that the retainer 33′ includes a protrusion 62. Other structural features are the same as those of the electrode assembly retainer 33 of the first embodiment. The protrusion 62 is formed of an insulating material similar to that of the retainer 33′ and protrudes toward the electrode assembly 5 from the inclined portion 100′ of the retainer 33′. In this embodiment, the protrusion 62 is provided at an end portion 64 of the inclined portion 100′.

Because the electrode assembly retainer 33′ includes the protrusion 62 extending from the inclined portion 100′, the rear surface of the protrusion 62 is provided closer to the electrode assembly 5, and the protrusion 62 comes into contact with the electrode assembly 5. The angle A of the inclined portion 100′ is 5° or more and 20° or less. When the angle A is 5° or more, a portion of the protrusion 62 extending from the inclined portion 100′ readily contacts the electrode assembly 5, thereby restraining the electrode assembly 5 at the contact point between the protrusion 62 and the electrode assembly 5. When the angle A is 20° or less, deformation of the electrode assembly 5 (the Z-direction deformation) caused by contact with the protrusion 62 can be suppressed while still sufficiently restraining the electrode assembly 5 by means of the retainer 33′.

The protrusion 62 is provided so as not to overlap the second through-hole 50′ of the electrode assembly retainer 33′ in the Z-direction, and it is provided at the end portion 64 of the inclined portion 100′. Because the protrusion 62 is provided at the end portion 64 of the inclined portion 100′, the protrusion 62 is sufficiently distant from the external terminal 23 to which load is applied. As a result, the protrusion 62 tends to deform in the Z-direction under load, allowing the protrusion 62 to readily contact the electrode assembly 5.

The thickness D of the protrusion 62 is 1.03 times or more and 1.5 times or less the thickness D′ of the first substrate portion 31a of the conductive member 31. Because the thickness D of the protrusion 62 is 1.03 times or more the thickness D′ of the first substrate portion 31a, the protrusion 62 is thicker than the first substrate portion 31a and therefore more readily contacts the electrode assembly 5 than the first substrate portion 31a. An insulating sheet (not shown) may be attached around the electrode assembly 5. From the standpoint of preventing short circuit of the electrode assembly 5, it is preferable that the first substrate portion 31a not excessively contact the electrode assembly 5 in the Z-direction, and that the insulating protrusion 62 sufficiently contact the electrode assembly 5. Furthermore, by limiting the thickness D of the protrusion 62 is 1.5 times or less the thickness D′ of the first substrate portion 31a, the volume of the protrusion 62, which does not contribute to battery capacity can be kept appropriately small inside the secondary battery 1, while still enabling the secondary battery 1 to have sufficient capacity.

Preferably, the protrusion 62 is provided in contact with the first substrate portion 31a of the conductive member 31. This allows the protrusion 62 to suppress excessive deformation of the first substrate portion 31a in the Z-direction. Additionally, by providing the protrusion 62 in contact with the first substrate portion 31a, the width (X-direction) of the protrusion 62 can be kept large. Consequently, a large contact area can be ensured between the protrusion 62 and the electrode assembly 5 in the width direction (X-direction), thereby enabling sufficient restraint of the electrode assembly 5.

In the secondary battery 1′ of the second embodiment described above, the electrode assembly retainer 33′ includes the protrusion 62, the rear surface of which is positioned closer to the electrode assembly 5, and the protrusion 62 contacts the electrode assembly 5. Because the angle A of the inclined portion 100′ is 5° or more and 20° or less, at least part of the protrusion 62 extending from the inclined portion 100′ readily contacts the electrode assembly 5, enabling the electrode assembly 5 to be restrained at the contact surface between the protrusion 62 and the electrode assembly 5.

According to at least one embodiment of the secondary battery 1 described above, the electrode assembly retainer 33 has the inclined portion 100, and the angle A of the inclined portion 100 is 5° or more and 20° or less. Consequently, the inclined portion 100 of the electrode assembly retainer 33 contacts the electrode assembly 5, and the electrode assembly 5 can be sufficiently restrained at the contact point or contact surface between the retainer 33 and the electrode assembly 5.

Furthermore, in some cases a conductive member 31 is provided in the width direction (the X-direction) of the secondary battery 1, in which case the angle B of the conductive member 31 is 65° or more and 85° or less. In such a case, since the second substrate portion 31b of the conductive member 31 is provided inside the current collector tabs 70 in the width direction (the X-direction) of the secondary battery 1, the electrode assembly 5 can be restrained by the conductive member 31 over a wide range in the X-direction. In some cases, the insulating cover 34 is also provided in the width direction (the X-direction) of the secondary battery 1, in which case the electrode assembly 5 is also restrained by the insulating cover 34 in the X-direction.

In this embodiment, the electrode assembly 5 is restrained not only in the height direction (the Z-direction) by the inclined portion 100 of the electrode assembly retainer 33, but also in the width direction (the X-direction) by the conductive member 31 and the insulating cover 34. As a result, is the electrode assembly 5 sufficiently restrained in both the X-direction and the Z-direction, and even when external loads such as vibration or are impact applied to the secondary battery 1, displacement of the electrode assembly 5 can be suppressed by the electrode assembly retainer 33, the conductive member 31, and the insulating cover 34, thereby achieving excellent vibration and impact resistance. Accordingly, breakage of portions of the electrode assembly 5 due to displacement, an increase in resistance or a decrease in capacity of the secondary battery 1 due to such breakage, and even short circuit can be suppressed.

Examples will be described below, but the present invention is not limited to examples described below without departing from the scope of the invention.

### EXAMPLES

The vibration-resistance performance of the secondary battery 1 of the first embodiment was evaluated by a vibration test in accordance with UN-T3. In the electrode assembly retainer 33, the first inclined portion 100a and the second inclined portion 100b were provided separately, and the conductive member 31 was provided with the angle B. The method of forming the inclined portions 100 and the angle B was as follows.

First, the electrode assembly retainer 33 having the second through-hole 50 was disposed beneath the lid member 7 having the first through-hole 20, and then the conductive member 31 having the third through-hole 60 was provided. The shaft portion 55 of the external terminal 23 was then inserted into the first through-hole 20, the second through-hole 50, and the third through-hole 60. Thereafter, by applying an appropriate load from above the external terminal 23, the external terminal 23 was brought into close contact with the first through-hole 20 of the lid member 7, the second through-hole 50 of the electrode assembly retainer 33, and the third through-hole 60 of the conductive member 31. This load was applied, the electrode assembly retainer 33 and the conductive member 31 undergo deformation due to the load, thereby the inclined portions 100 and the angle B were formed.

In the electrode assembly 5 inside the secondary battery 1, the current collector tabs 70 were clamped by the metal members 16, and the metal members 16 were electrically connected to the conductive member 31.

Examples 1 to 8 and Comparative Examples 1 to 3 are described below.

### Example 1

The angle A of the inclined portion 100 of the electrode assembly retainer 33 was 15°, and the total of the distances T of the inclined portion 100 was 65% of the length W of the lid member 7. In addition, the angle B formed by the first substrate portion 31a and the second substrate portion 31b was 70°.

### Example 2

The angle A of the inclined portion 100 of the electrode assembly retainer 33 was 5°. Other conditions were the same as those of Example 1.

### Example 3

The angle A of the inclined portion 100 of the electrode assembly retainer 33 was 20°. Other conditions were the same as those of Example 1.

### Example 4

The total of the distances T of the inclined portion 100 was 60% of the length W of the lid member 7. Other conditions were the same as those of Example 1.

### Example 5

The total of the distances T of the inclined portion 100 was 75% of the length W of the lid member 7. Other conditions were the same as those of Example 1.

### Example 6

The total of the distances T of the inclined portion 100 was 50% of the length W of the lid member 7. Other conditions were the same as those of Example 1.

### Example 7

The angle B formed by the first substrate portion 31a and the second substrate portion 31b was 65°. Other conditions were the same as those of Example 1.

### Example 8

The angle B formed by the first substrate portion 31a and the second substrate portion 31b was 90°. Other conditions were the same as those of Example 1.

### Comparative Example 1

The angle A of the inclined portion 100 of the electrode assembly retainer 33 was 3°. Other conditions were the same as those of Example 1.

### Comparative Example 2

The angle A of the inclined portion 100 of the electrode assembly retainer 33 was 30°. Other conditions were the same as those of Example 1.

### Comparative Example 3

The angle A of the inclined portion 100 of the electrode assembly retainer 33 was 45°. Other conditions were the same as those of Example 1.

| | | (the sum of | | the results of |
|---|---|---|---|---|
| | angle | distances T/the | angle | the vibration |
| | A/° | length W)/% | B/° | test |
| Example 1 | 15 | 65 | 70 | Excellent |
| Example 2 | 5 | 65 | 70 | Excellent |
| Example 3 | 20 | 65 | 70 | Excellent |
| Example 4 | 15 | 60 | 70 | Excellent |
| Example 5 | 15 | 75 | 70 | Excellent |
| Example 6 | 15 | 50 | 70 | Good |
| Example 7 | 15 | 65 | 65 | Excellent |
| Example 8 | 15 | 65 | 90 | Good |
| Comparative | 30 | 65 | 70 | Fair |
| Example 1 | | | | |
| Comparative | 45 | 65 | 70 | Fair |
| Example 2 | | | | |

Table 1 shows the results of the vibration test in each of Examples and Comparative Examples. After the vibration test, the secondary battery 1 was disassembled, and the current collector tabs 70 of the electrode assembly 5 were evaluated as follows: “Excellent” indicates that no breakage occurred; “Good” indicates that cracking occurred; and “Fair” indicates that breakage occurred.

As shown in Table 1, when the Examples were compared with the Comparative Examples, it was verified that when the angle A of the inclined portion 100 was set to 5° or more and 20° or less, no breakage occurred in the current collector tabs 70 of the electrode assembly 5 even after the vibration test. This confirms that, by setting the angle A of the inclined portion 100 to 5° or more and 20° or less, the inclined portion 100 of the electrode assembly retainer 33 comes into contact with the electrode assembly 5, enabling sufficient restraint of the electrode assembly 5 at the contact point even when the secondary battery 1 is subjected to vibration.

As shown in Comparative Example 1, when the angle A of the inclined portion 100 is 3°, the inclined portion 100 does not contact the electrode assembly 5 and therefore cannot sufficiently restrain the electrode assembly 5 when the secondary battery 1 is subjected to vibration. In contrast, as shown in Comparative Examples 2 and 3, when the angle A of the inclined portion 100 is 30° or more, deformation (the Z-direction deformation) of the electrode assembly 5 occurs due to contact with the inclined portion 100, resulting in breakage of the current collector tabs 70. This is because deformation of the electrode assembly 5 caused by contact with the inclined portion 100 allows vibration of the secondary battery 1 to be transmitted directly to the current collector tabs 70 that have not been deformed, thereby causing breakage of the current collector tabs 70.

Comparing Example 1, Example 5, and Example 6, it was verified that the total of the distances T of the inclined portion 100 is preferably 60% or more and not 75% or less of the length W of the lid member 7. As shown in Example 6, when the total of the distances T is 50% of the length W, the end portion 64 of the inclined portion 100 is not sufficiently distant from the external terminal 23 to which load is applied. Therefore, deformation in the Z-direction is less likely to occur particularly at the end portion 64 under load, and the inclined portion 100 may not readily contact the electrode assembly 5.

Comparing Example 1, Example 7, and Example 8, it was verified that the angle B formed between the first substrate portion 31a and the second substrate portion 31b of the conductive member 31 is preferably 65° or more and 85° or less. As shown in Example 8, when the angle B is 90°, the second substrate portion 31b of the conductive member 31 does not enter inside the current collector tabs 70, and the restraint of the electrode assembly 5 in the width direction (the X-direction) may be insufficient.

The vibration test results described above are applied to the secondary battery 1 of this embodiment. Specifically, the electrode assembly retainer 33 includes the inclined portion 100, and the angle A of the inclined portion 100 is 5° or more and 20° or less. In the inclined portion 100 of the retainer 33, if T denotes the maximum distance measured parallel to the long side of the lid member 7, the total of these distances T is preferably 60% or more and 75% or less of the length W of the long side of the lid member 7. Furthermore, the angle B formed by the first substrate portion 31a and the second substrate portion 31b of the conductive member 31 toward the inclined portion 100 is preferably 65° or more and 85° or less.

As a result, the inclined portion 100 of the electrode assembly retainer 33 contacts the electrode assembly 5, and the electrode assembly 5 can be sufficiently restrained at the contact point or contact surface. When the conductive member 31 is provided in the width direction (the X-direction) of the secondary battery 1, the second substrate portion 31b of the conductive member 31 is provided inside the current collector tabs 70 in the width direction (the X-direction) of the secondary battery 1, the electrode assembly 5 can be restrained by the conductive member 31 over a wide range in the X-direction. In some cases, the insulating cover 34 is also provided in the width direction (the X-direction) of the secondary battery 1, in which case the electrode assembly 5 is also restrained by the insulating cover 34 in the X-direction.

In this embodiment, the electrode assembly 5 is restrained not only in the height direction (the Z-direction) by the inclined portion 100 of the electrode assembly retainer 33, but also in the width direction (the X-direction) by the conductive member 31 and the insulating cover 34. As a result, the electrode assembly 5 is sufficiently restrained in both the X-direction and the Z-direction, and even when external loads such as vibration or impact are applied to the secondary battery 1, displacement of the electrode assembly 5 can be suppressed by the electrode assembly retainer 33, the conductive member 31, and the insulating cover 34, thereby achieving excellent vibration and impact resistance. Accordingly, breakage of the tabs or lead portions of the electrode assembly 5 due to displacement, increases in resistance or decreases in capacity and even short circuit can be suppressed.

Although some embodiments of the present invention have been described, these embodiments have been presented as examples and are not intended to limit the scope of the invention. These embodiments can be implemented in various other forms, and various omissions, substitutions, and changes can be made without departing from the gist of the invention. These embodiments and modifications thereof are included in the scope and gist of the invention and are included in the invention described in the claims and the equivalent scope thereof.

For example, as described above, the electrode assembly is not limited to a so-called wound-type electrode assembly formed by winding electrode plates. A so-called stacked-type electrode assembly, in which a plurality of electrode plates is laminated in the thickness direction, may also be employed. The materials, shapes, sizes, and other characteristics of the components constituting the secondary battery are not limited to those described in the above embodiments and may be variously modified as necessary.

What is claimed is:

1. A secondary battery, comprising:
an outer case including a bottom wall, a side wall, and an aperture portion;
an electrode assembly in the outer case and including a positive electrode, a negative electrode;
a lid member disposed at the aperture portion and having a first through-hole;
an electrode assembly retainer provided between the electrode assembly and the lid member and having a second through-hole; and
an external terminal having a shaft portion in the first through-hole and the second through-hole, wherein
the electrode assembly retainer includes an inclined portion that is inclined with respect to the lid member at an angle of 5° or more and 20° or less in the insertion direction of the electrode assembly.

2. The secondary battery of claim 1, wherein
the external terminal includes a positive external terminal connected to the positive electrode and a negative external terminal connected to the negative electrode,
the inclined portion includes a first inclined portion on the positive external terminal side and a second inclined portion on the negative external terminal side, and
the first inclined portion and the second inclined portion are provided separately from each other.

3. The secondary battery of claim 1, wherein
the lid member includes a gas vent valve and a liquid injection port, and
the inclined portion is provided so as not to overlap, in the insertion direction of the electrode assembly, with at least one of the gas vent valve and the liquid injection port.

4. The secondary battery of claim 1, wherein
the lid member has a rectangular shape with long sides and short sides, and
the sum of the maximum distances of the inclined portion measured parallel to the long side of the lid member is 60% or more and 75% or less of the length of the long side.

5. The secondary battery of claim 1, further comprising:
a conductive member having a third through-hole connected to the shaft portion of the external terminal, wherein
the conductive member includes a first substrate portion provided between the electrode assembly and the electrode assembly retainer, and a second substrate portion provided between the electrode assembly and the side wall of the outer case and connected to the first substrate portion, and
in the insertion direction of the electrode assembly, the angle formed by the first substrate portion and the second substrate portion toward the inclined portion is 65° or more and 85° or less.

6. The secondary battery of claim 5, wherein
the electrode assembly retainer includes a protrusion extending from the inclined portion toward the electrode assembly, and
the protrusion is provided at the end portion of the inclined portion so as not to overlap the second through-hole.

7. The secondary battery of claim 6, wherein
a thickness of the protrusion is 1.03 times or more and 1.5 times or less a thickness of the first substrate portion of the conductive member.
